(19) United States
(12) Patent Application Publication
(10) Pub. No.: US 2009/0249777 A1
(43) Pub. Date: Oct. 8, 2009

(54) TRANSMISSION DEVICE WITH AT LEAST ONE FORM-FIT SHIFTING ELEMENT BEING HYDRAULICALLY ACTUATED VIA A HYDRAULIC SYSTEM

(75) Inventors: Christian POPP, Kressbronn (DE); Thilo SCHMIDT, Meckenbeuren (DE); Klaus STEINHAUSER, Kressbronn (DE); Jorg ARNOLD, Immenstaad (DE); Valentine HERBETH, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/419,682

(22) Filed: Apr. 7, 2009

(30) Foreign Application Priority Data
Apr. 8, 2008 (DE) 10 2008 001 039.1

(51) Int. Cl. F16H 43/00

(52) U.S. Cl. 60/469; 60/494

(57) ABSTRACT

A transmission device (10) having at least one form-fitting shifting element (12) which is hydraulically actuated via a hydraulic system (11) with hydraulic pressure (p_{—}12), in the area of a piston chamber, via a feed line (20) that conveys hydraulic fluid, to shift from a disengaged to and engaged operating state. A non-return valve device (27) is arranged upstream of the form-fit shifting element (12).

This application claims priority from German patent application serial no. 10 2008 001 039.1 filed Apr. 8, 2008.

### FIELD OF THE INVENTION

The invention relates to a transmission device with at least one form-fit shifting element being actuated via a hydraulic system.

### BACKGROUND OF THE INVENTION

Generally, transmission devices, or, as the case may be, automatic transmission devices known from practice are provided with oil-cooled, frictionally-engaged shifting elements, like multiple-disk clutches or brakes. The transmission capacity of such frictionally engaged shifting elements is adjusted, for example, via a piston being acted upon by hydraulic pressure, and which, depending on the hydraulic pressure applied to it at any given time, presses on a disk pack, which consists of the inner and outer disks of a shifting element, with a force that depends on the pressure acting on it. The torque that can be transmitted at any given time by a shifting element is ideally proportional to the actuating pressure applied to the piston in order to enable continuous switching of the clutch.

Transmission devices of this type allow the performance of so-called power shifts without interruption in tractive force, where the torque to be transmitted via a transmission device is transmitted prior to a power shift by a shifting element that is engaged in the force flow of the transmission device, and after the power shift, by a shifting element that is in the first instance disengaged from the force flow, and during the power shift is engaged in the force flow when the load-bearing shifting element is disengaged to the desired extent during the power shift.

In this connection, the volume flow required to actuate a form-fit shifting element is continuously adjusted to the hydraulic pressure present in the hydraulic system, a predictable pressure-volume flow from the supplying hydraulic system always resulting from the displacement-pressure behavior of the shifting element. As a result of this predictability, pressure peaks in the hydraulic system can be avoided by means of proper activation of the hydraulic system.

Automatic transmissions and twin-clutch transmissions are often configured with shifting elements, or, as the case may be, clutches that can only be engaged or disengaged during load-free operating states, or nearly load-free operating states, of a transmission device. Such shifting elements are, for example, form-fit dog clutch, or dog clutch elements configured as synchronization devices.

In the case of form-fit shifting elements which are hydraulically actuated, the hydraulic piston is disadvantageously displaced with a highly variable force-displacement course. Only a slight force, or, as the case may be, a low operating pressure is required to displace the piston until the piston encounters an obstacle and its movement is stopped. This occurs, for example, when the two halves of a form-fit shifting element, to be engaged in a form-fitting manner with one another come into contact without locking with one another in a form-fitting manner. When a form-fit shifting element is in an operating state of this kind, essentially no torque can be transferred via a form-fit shifting element.

As the movement of the actuating piston of a form-fit shifting element is stopped abruptly the moment it makes contact, the hydraulic fluid volume flow supplied to the shifting element from the pressure supply unit of a hydraulic system of the transmission device for actuating the shifting element must be instantly, or, as the case may be, abruptly reduced in order to avoid a sudden rise in the pressure in the hydraulic system, undesirably high pressure peaks being nevertheless generated in the hydraulic system.

This results from the fact that events of this kind during the operation of a form-fit shifting element are subject to the position of the two clutch halves of a form-fit shifting element relative to one another, are not predictable when using the known encoder systems that are assigned to a form-fit shifting element, and the corresponding control cannot be started in time.

If the two clutch halves of a form-fit shifting element to be joined in a form-fitting manner mesh after a so-called synchronization phase, the piston of a form-fit shifting element, which is still being acted upon by an operating pressure, further moves abruptly from the moment of meshing. As a result of the sudden movement of the piston, a sudden rise in the hydraulic fluid volume flow from the hydraulic system in the direction of the piston chamber of the shifting element is required in order to avoid a significant drop in pressure in the hydraulic system. However, the hydraulic volume flow can only be increased with some delay via the corresponding actuation of various valve devices of the hydraulic system.

When the actuating piston of the form-fit shifting element reaches an end-stop equivalent to an engaged operating state of the shifting element, the actuating piston is in turn brought to an abrupt stop. This in turn leads to a new rise in hydraulic pressure in the hydraulic system, which has to be reduced to the required level by correspondingly actuating various components of the hydraulic control system. Reaching the end-stop of the actuating piston produces a so-called pressure overshoot in the pressure course of the operating pressure of a form-fit shifting element.

Furthermore, when there is a drop in pressure in a part of the hydraulic system of a transmission device that supplies working pressure to a form-fit shifting element, there is also the disadvantageous possibility that the form-fit shifting element will automatically and undesirably disengaged during adverse operating states, and the force flow in the transmission device will be interrupted.

### SUMMARY OF THE INVENTION

The object of the present invention is to provide a transmission device with at least one form-fit shifting element being actuated via a hydraulic system, with which undesirable opening of a form-fit shifting element during drops in pressure in hydraulic systems can be avoided in a simple and cost-efficient manner.

In the inventive transmission device with at least one shifting element being hydraulically actuated via a hydraulic system, in which the shifting element is acted upon in the area of a piston chamber by a hydraulic fluid conveyed by a feed line and can be transferred from a disengaged to an engaged operating state, a non-return valve device is arranged upstream of the form-fit shifting element.

When there is a drop in pressure in the hydraulic system subject to an operating state below the operating pressure of the form-fit shifting element, undesirable disengagement of a form-fit shifting element, which is due primarily to a return of the piston of the shifting element to its starting position in which the form-fit shifting element is essentially in a disengaged operating state, can be avoided in a simple and cost-efficient manner by means of the non-return valve device, ensuring via the non-return valve that the piston chamber of the form-fit shifting element is not de-aerated in the direction of an area of the hydraulic system that preferentially conveys system pressure.

In order to guarantee secure disengagement of the form-fit shifting element in the event of a malfunction of the valve device provided for adjusting the operating pressure of the form-fit shifting element, an embodiment of the inventive transmission device provides for the non-return valve device to be switchable between at least two operating positions, the non-return valve device being through-flowable in the filling direction of the piston chamber of the form-fit shifting element and a backflow through the non-return valve device against the filling direction of the piston chamber of the form-fit shifting element being blocked, and where, in the second operating position of the non-return valve device, hydraulic fluid can be conveyed in the filling direction of the piston chamber via the non-return valve device.

Alternatively, the non-return valve device is configured with a bypass throttle, via which hydraulic fluid from the form-fit shifting element can be conveyed past the non-return valve device against the blocked direction of the non-return valve in order to guarantee secure engagement of the clutch in case of malfunction of the valve device.

In order to allow the adjustment of the operating pressure of the form-fit shifting element independently of the mode of operation of the non-return valve, in a further development of the inventive transmission device, a valve device provided for adjusting the actuating pressure of the shifting element is arranged between the non-return valve device and the form-fit shifting element.

In an advantageous embodiment of the inventive transmission device, a first control guide of the valve device is connected to a line conveying a system pressure and a second control guide of the valve device is connected to a non-pressurized area of the hydraulic system, which can be operatively connected to one other subject to an adjustment of a valve slide of the valve device for switching the form-fit shifting element, or, as the case may be, its piston chamber, at zero pressure.

In an advantageous embodiment of the inventive transmission device, the feed line of the shifting element, which conveys hydraulic fluid and connects the form-fit shifting element to the valve device, is operatively connected to a damping device, by means of which pressure fluctuations of the hydraulic pressure present in the feed line can be at least partially compensated for. During actuation of a form-fit shifting element, pressure fluctuations occurring because of a strongly varying force-displacement curve are damped in the hydraulic system in the area of the damping device, and back-couplings of massive pressure peaks in the direction of the hydraulic system actuating the shifting element are avoided in a simple and cost-efficient manner.

In order to position the damping device in a hydraulic control of the hydraulic system, a throttling device is arranged between the damping device and the valve device provided for adjusting the operating pressure of the form-fit shifting element.

In a constructively simple embodiment of the inventive transmission device, the damping device comprises a spring device that can be acted upon in the active area of a damping element by the hydraulic pressure of the feed line, the elastic force of the spring device working against the compressive force of the hydraulic pressure acting on the damping element.

In an advantageous further embodiment of the invention, the elastic force of the spring device that works against the hydraulic compressive force is greater than a maximum hydraulic operating force of an actuating piston of the shifting element, whereby, during engagement of a form-fit shifting element, a movement of the actuating piston of the shifting element is not impinged on by the damping device, and the damping effect of the damping device only takes place when there is an undesirable rise in the operating pressure of the form-fit shifting element.

Additionally or alternatively, in an advantageous embodiment of the inventive transmission device, the elastic force of the spring device that works against the hydraulic compressive force is smaller than a minimum system pressure of the hydraulic system, whereby the functionality of the damping device is available across the entire operating range of the transmission device.

An embodiment of the inventive transmission device that is particularly advantageous in terms of installation space and assembly is characterized in that the damping device is integrated in the form-fit shifting element.

In an advantageous further embodiment of the inventive transmission device, the damping device comprises a single-acting piston-cylinder unit, the damping element of the damping device being configured as a piston that is axially displaceable inside a cylinder, the piston being preferably arranged coaxially to the actuating piston of the shifting element. The damping device that is configured as a piston-cylinder unit is an embodiment that can be produced simply and cost-efficiently, and can be integrated in the transmission device in a user-defined manner.

The piston of the damping device and the piston of the shifting element are configured as radially adjacent annular pistons in an embodiment of the inventive transmission device that requires little installation space.

In a further advantageous embodiment of the inventive transmission device, the actuating piston of the form-fit shifting element communicates with a stroke measurement system, by means of which at least one end position of the actuating piston of the shifting element in which the actuating piston of the shifting elements is in an engaged operating state can be verified. This provides the possibility of continuously reducing the hydraulic fluid volume flow supplied to the form-fit shifting element, or, as the case may be, its piston chamber, via a pilot valve or similar, shortly before the end position of the actuating piston is reached in order to avoid pressure fluctuations in the hydraulic system.

Further advantages and advantageous further embodiments of the invention arise from the patent claims and the exemplary embodiments described below in principle with reference to the drawing, whereas in the description of the exemplary embodiments the components identical in construction and function carry the same reference numerals for the sake of clarity.

### BRIEF DESCRIPTION OF THE DRAWINGS

The drawings show:

FIG. 1 a highly schematic diagram of the drive train of a motor vehicle, which is accomplished with the inventive transmission device.

FIG. 2 a hydraulic circuit diagram of a part of a hydraulic system of the transmission device according to FIG. 1, via which a form-fit shifting element is actuated;

FIG. 3 a diagram of a second exemplary embodiment of the transmission device according to FIG. 1 corresponding to FIG. 2;

FIG. 4 a diagram of a third exemplary embodiment of the transmission device corresponding to FIG. 2, in which a damping device is arranged outside a hydraulic control of the hydraulic system;

FIG. 5 a diagram of a fourth exemplary embodiment of the transmission device corresponding to FIG. 2, in which an electrohydraulic actuator is assigned to a valve device that adjusts the actuating pressure for the form-fit shifting element;

FIG. 6 a highly schematic longitudinal sectional view of a first embodiment of the form-fit shifting element of the transmission device;

FIG. 7 a diagram of a second embodiment of the form-fit shifting element of the transmission device corresponding to FIG. 6;

FIG. 8 a plurality of curves of different operating state parameters of a transmission device during an engagement and subsequent disengagement of a form-fit shifting element being hydraulically actuated, whereby the transmission device is accomplished without a damping device; and

FIG. 9 a plurality of curves of different operating state parameters of the transmission device during an engagement and subsequent disengagement procedure of the form-fit shifting element being hydraulically operated to which the damping device is assigned.

### DETAILED DESCRIPTION OF THE PREFERRED EMBODIMENTS

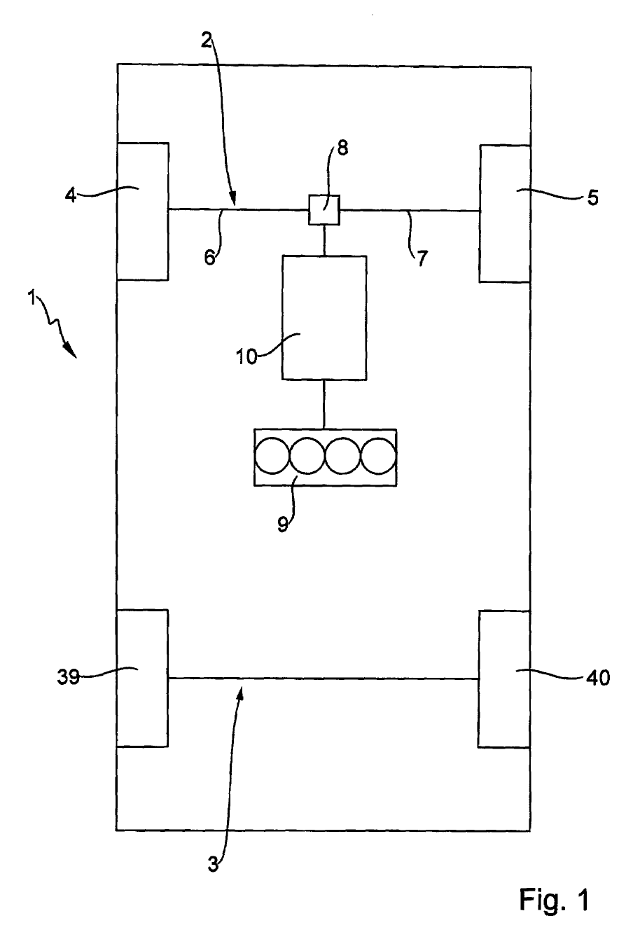

FIG. 1 one shows a highly schematic diagram of a vehicle drive train of a vehicle 1 with a first vehicle axle 2 and a second vehicle axle 3. The first vehicle axle 2 is a front vehicle axle and the second vehicle axle 3 represents the rear vehicle axle of the vehicle 1, which in each case includes the drive wheels 4, 5, or, as the case may be, the wheels 39, 40. The drive wheels 4, 5 are connected to a differential gear unit 8 via two input shafts 6, 7.

By means of the differential gear unit 8, a torque that is produced by a power unit 9, which in this case is configured as an internal combustion engine, which could also be a hybrid drive, is equally distributed on both drive wheels 4 and 5. In addition, between the power unit 9 and the differential gear unit 8 a transmission 10 is provided, which can be executed as an automatic transmission, as a twin-clutch transmission or the like, and by means of which different transmission gears can be represented in the inherently known manner.

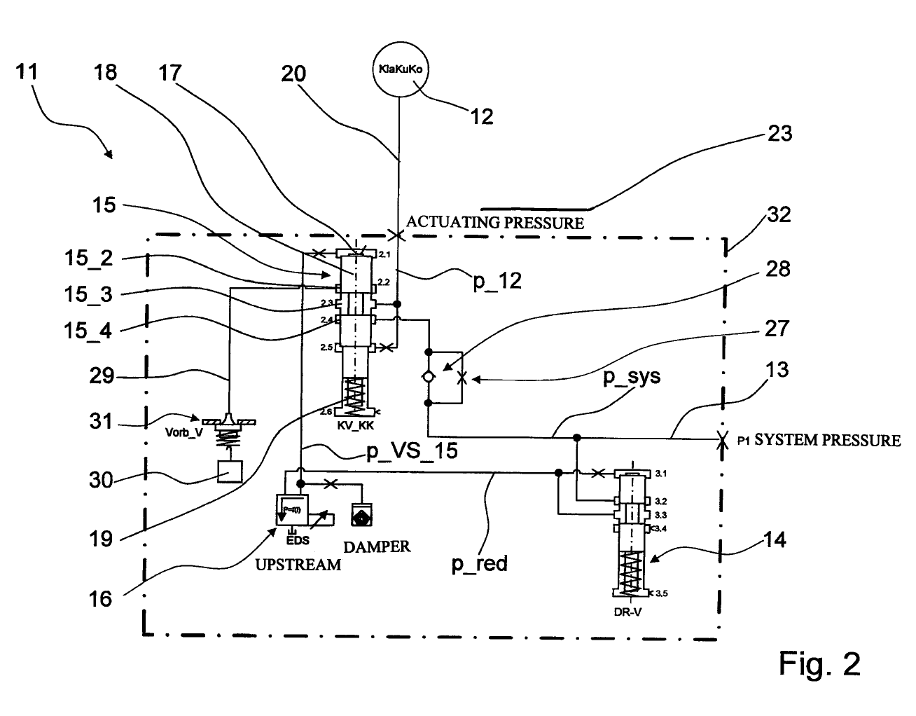

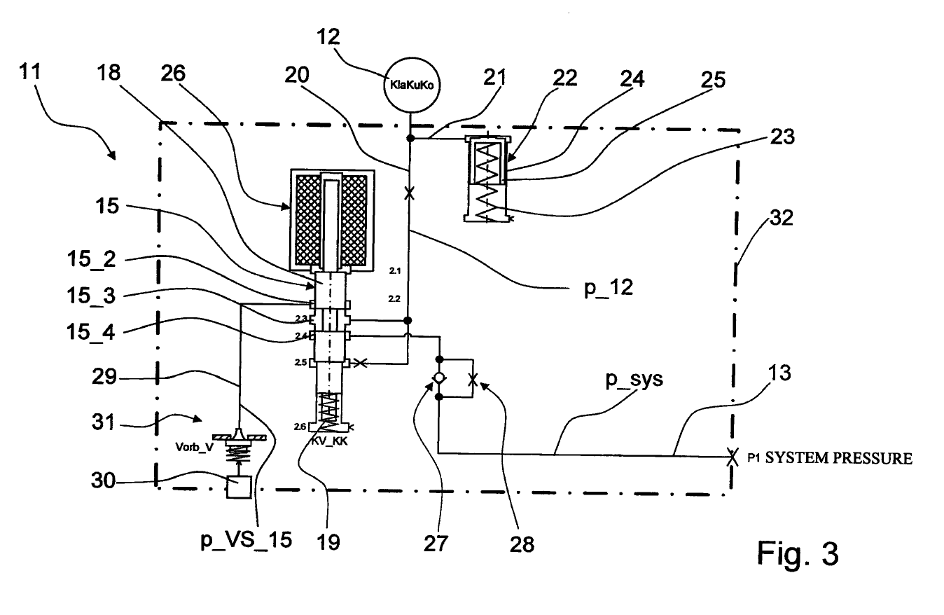

FIG. 2 to FIG. 5 respectively show a hydraulic diagram of part of a hydraulic system 11 of the transmission device 10, via which a form-fit shifting element 12 of the transmission device 10 can be hydraulically activated in each case. The various embodiments of the hydraulic system 11 of the transmission device 10 in each case only differ in sections, which is why in the description of the embodiments according to FIG. 3 to FIG. 5, reference is essentially made in each case only to the differences from the first exemplary embodiment of the hydraulic system 11 shown in FIG. 2.

In the first exemplary embodiment of the hydraulic system 11 shown in FIG. 2, a system pressure p_sys present in the hydraulic system 11 is applied via a first hydraulic line 13, and this system pressure is adjusted in the area of a system pressure valve that is not shown in more detail. The system pressure p_sys is transferred both in the direction of a so-called pressure-reducing valve 14 and in the direction of a valve device 15. In the area of the pressure-reducing valve 14, the system pressure p_sys is adjusted to a reduction pressure p_red, which is in turn transferred in the direction of an electrohydraulic actuator 16.

In the area of the electrohydraulic actuator, or, as the case may be, the electric control valve 16, a so-called pilot pressure p_VS_15 of the valve device 15 is adjusted depending on an impinging control flow, and applied in the area of a control surface 17 of a valve slide 18 of the valve device 15, so that that a compressive force is applied to the valve slide 18, the force resulting from the pilot pressure p_VS_15 and working against an elastic force of a first spring device 19.

Subject to the pilot pressure p_VS_15, a system pressure p_sys impinging on a fourth control guide 15_4 of the valve device 15 is transferred, at a correspondingly converted level, via a third control guide 15_3 in the direction of the form-fit shifting element 12, or, as the case may be, in the direction of a piston chamber of the shifting element 12, which is not shown in more detail in FIG. 2.

Between the third control guide 15_3 of the valve device 15 and the form-fit shifting element 12, a second hydraulic line 21 branches off a feed line 20 of the shifting element 12, the hydraulic line connecting the feed line 20 to a damping device 22 in the exemplary embodiments shown in FIG. 3 to FIG. 5. The exemplary embodiment according to FIG. 2 is accomplished without the damping device, by means of which pressure fluctuations in the feed line 20 can at least be partially compensated for.

In order to compensate for the pressure fluctuations, the damping device 22 is accomplished with a second spring device 23, whose elastic force, in this instance, primarily impinges on a piston 25 that is axially displaceable inside a cylinder 24 of a single-acting piston-cylinder unit of the damping unit 22, the damping unit working against the compressive force that acts on the piston 25 via the second hydraulic line 21.

In the second exemplary embodiment of the hydraulic system 11 shown in FIG. 3, the valve device 15 is accomplished as a directly controlled operating valve, in which an axial position of the valve slide 18 is adjusted via an electromagnetic actuator, or, as the case may be, a proportional magnet 26. Furthermore, in all embodiments of the transmission device shown in FIG. 2 to FIG. 5, or, as the case may be, in the hydraulic system 11, a non-return valve device 27 with a bypass throttle 28 is provided upstream of the valve device 15, or, as the case may be, downstream of the fourth control guide 15_4 of the valve device 15. The non-return valve device 27 releases the flow direction of a hydraulic fluid volume flow conveyed by the first hydraulic line 13 in the direction of the valve device 15, and thus in the direction of the form-fit shifting element 12, while a backflow originating from the fourth control guide 15_4 of the valve device 15 via the non-return valve device 27 is blocked. In this way, a sudden drop in pressure is prevented in the region of the form-fit shifting element 12 in the event of a drop in the system pressure p_sys in a simple and cost-efficient manner, and preventing what under certain circumstances might be an undesirable disengagement of the form-fit shifting element 12 that results from this.

The shifting element 12 can be switched without pressure via the bypass throttle 28 in case of malfunction, whereby in the event of a failure of the valve device 15, safe opening of the shifting element is guaranteed. During normal modes of operation of the valve device 15, the feed line 20 can be connected via the valve slider 18 to a second control guide 15_2, which is connected to a non-pressurized area 30 of the transmission device 10 by means of a third hydraulic line 29.

In the third hydraulic line 29, a non-return valve 31 is provided between the second control guide 15_2 of the valve device 15 and the non-pressurized area 30, or, as the case may be, a hydraulic fluid reservoir, which in this case is the oil pan of the transmission device 10. Complete emptying of the hydraulic system 11 is prevented by means of this non-return valve 31 because the additional non-return valve 31 only opens at a pressure value that is preferably greater than 0.25 bar.

In the exemplary embodiment of the hydraulic system 11 of the transmission device 10 shown in FIG. 2, the hydraulic system 11 is accomplished without the non-return valve device 27 and without the bypass throttle 28 so that the shifting element 12 can be switched at zero pressure, both via the third hydraulic line 19 and, in the event of a correspondingly low system pressure p_sys via the first hydraulic line 13.

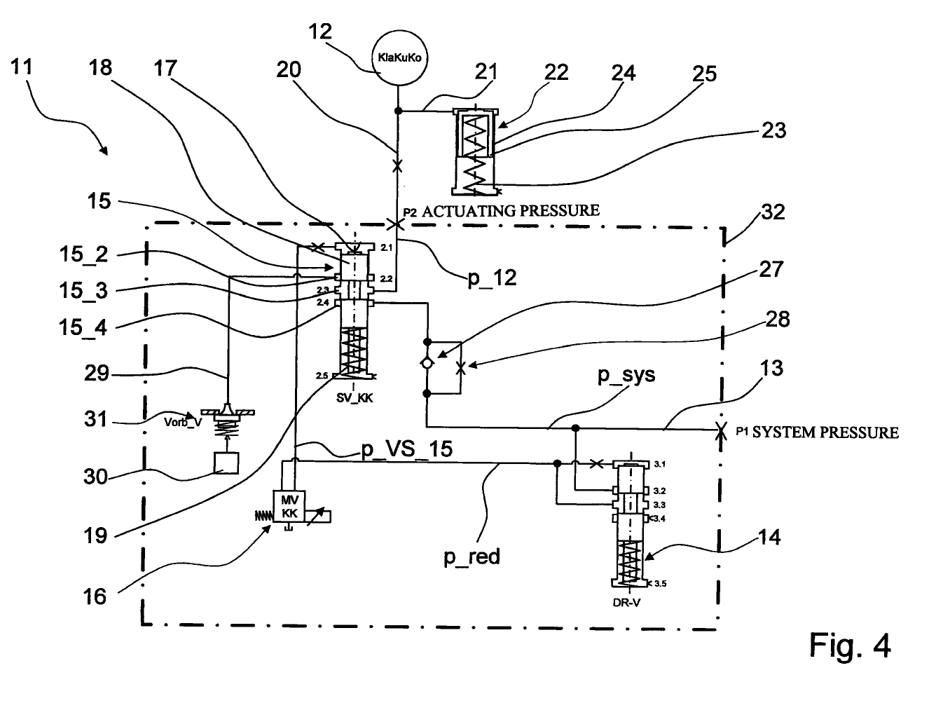

The fourth exemplary embodiment of the hydraulic system 11 shown in FIG. 4 is provided with an electrohydraulic actuator 16 accomplished as a magnetic valve in order to enable adjustment of the pilot pressure p_VS_15 of the valve device 15 independently of the operating state. In the region of the magnetic valve 16, the reduction pressure p_red is correspondingly converted, subject to an impinging operating flow, and then transferred in the direction of the control surface 17 of the valve device 15.

The damping device 22 is arranged outside a hydraulic control 32 of the hydraulic system 11, whereby between the valve device 15 and the damping device 22, a feed throttle 33a is provided, by means of which the piston 25 of the damping device 22 is separated from the valve device 15 that actuates the shifting element 12.

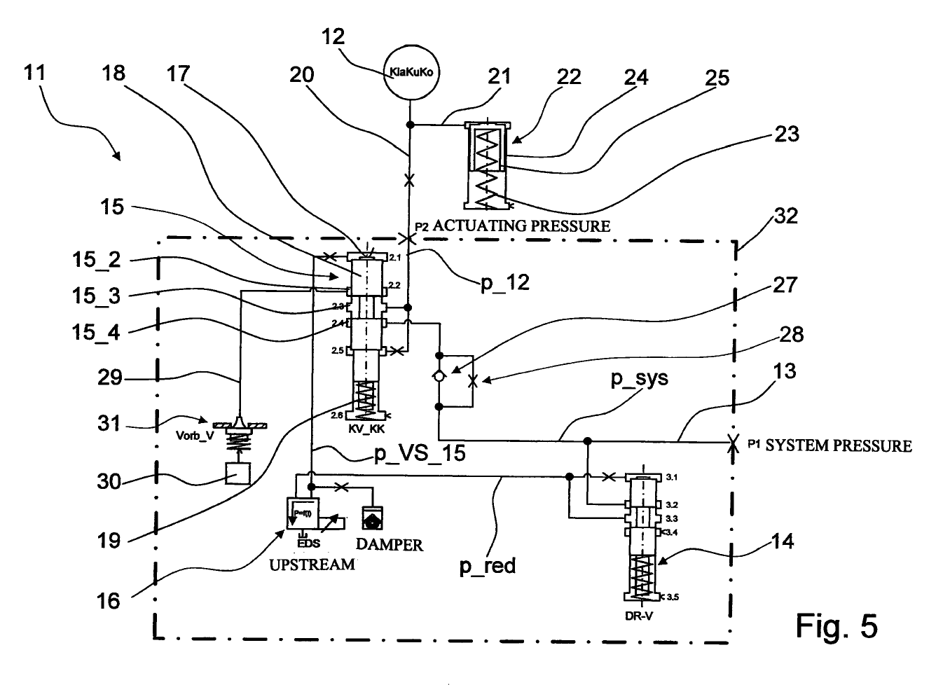

The fourth exemplary embodiment of the hydraulic system 11 shown in FIG. 5 essentially corresponds to the first exemplary embodiment shown in FIG. 2, in which, in contrast to the first exemplary embodiment, the damping device 22 is arranged outside the hydraulic control 32.

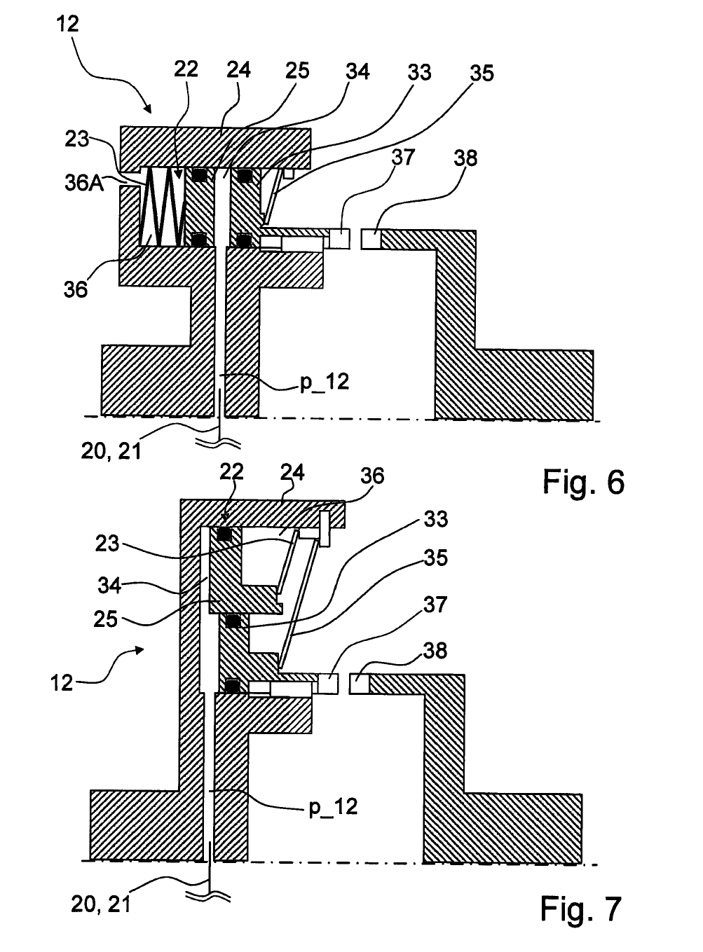

In FIG. 6 and FIG. 7, two concrete exemplary embodiments of the form-fit shifting element 12 are respectively illustrated in highly simplified individual longitudinal sectional views, whereby in both exemplary embodiments the damping device 22 is integrated in the shifting element 12 in an advantageously installation space-saving manner.

In the first exemplary embodiment of the shifting element 12 of the transmission device 10 shown in FIG. 6, an actuating piston 33 of the shifting element 12 and the piston 25 of the damping device 22 are arranged coaxially to one other and with a space between them in the axial direction, and delimit a common piston chamber 34, which is acted upon via the feed line 20 by the operating pressure p_12 that is adjusted in the area of the valve device 15.

The actuating piston 33 is impinged on by an elastic force of a third spring device 35 that acts in the opening direction of the shifting element 12, and this elastic force must be overcome by the operating pressure p_1 2 acting upon the piston chamber 34 in order to close the form-fit shifting element 12. The second spring device 23 of the damping device 22 is mounted in a spring chamber 36 that is arranged on the side of the piston 25 facing away from the piston chamber 34. The spring chamber 36 has with a vent bore 36A in order to avoid a buildup of pressure due to leakage flows from the piston chamber 34 in the direction of the spring chamber 36 that would impair the mode of operation of the damping unit 22.

In the second exemplary embodiment of the form-fit shifting element 12 shown in FIG. 7, the piston 25 of the damping device and the actuating piston 33 of the shifting element 12 are also arranged coaxially to one other and accomplished as radially adjacent annular pistons, whereby the piston 25 radially encloses the actuating piston 33.

In both exemplary embodiments of the form-fit shifting element 12 according to FIG. 6 and according to FIG. 7, the pressure-dependent volume flow requirement, or, as the case may be, the change in this requirement by the part of the hydraulic system 11 connected via the first hydraulic line 13, is damped by the piston 25 in the piston chamber 34 of the shifting element 12 to the extent that no massive pressure peaks are fed back via the first hydraulic line 13 originating from the piston chamber 34.

The actuating piston 33 of the form-fit shifting element 12 is configured as a single-acting cylinder piston that is put into a first end position, in which the form-fit shifting element 12 is completely disengaged by means of the third spring device 35, or, as the case may be, by means of a corresponding return spring, when the actuating pressure p_12 falls below a threshold value. If the hydraulic system 11 is designed to have a minimum pressure of 5 bar, the operating pressure of the return spring, or, as the case may be, the third spring device 35 of the shifting element 12, is set at approximately 1 to 2 bar. If there is a corresponding switching requirement, or, as the case may be, engagement of the form-fit shifting element 12, the operating pressure p_12 in the area of the valve device 15 is set at a pressure value that is far above the elastic force of the third spring device 35, whereby the largest possible volume flow in the direction of the piston chamber is conveyed in the direction of the piston chamber 34 in order to engage the form-fit shifting element.

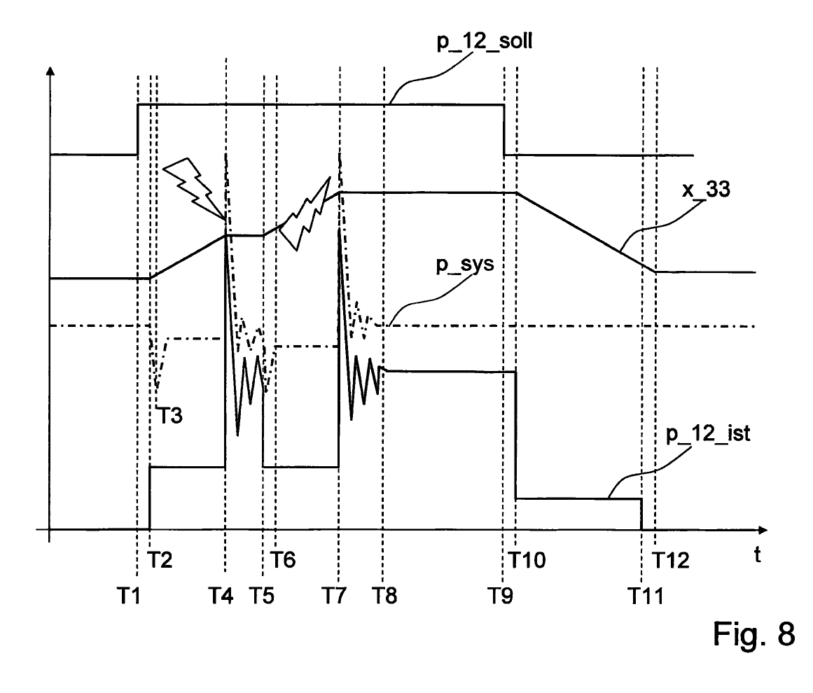

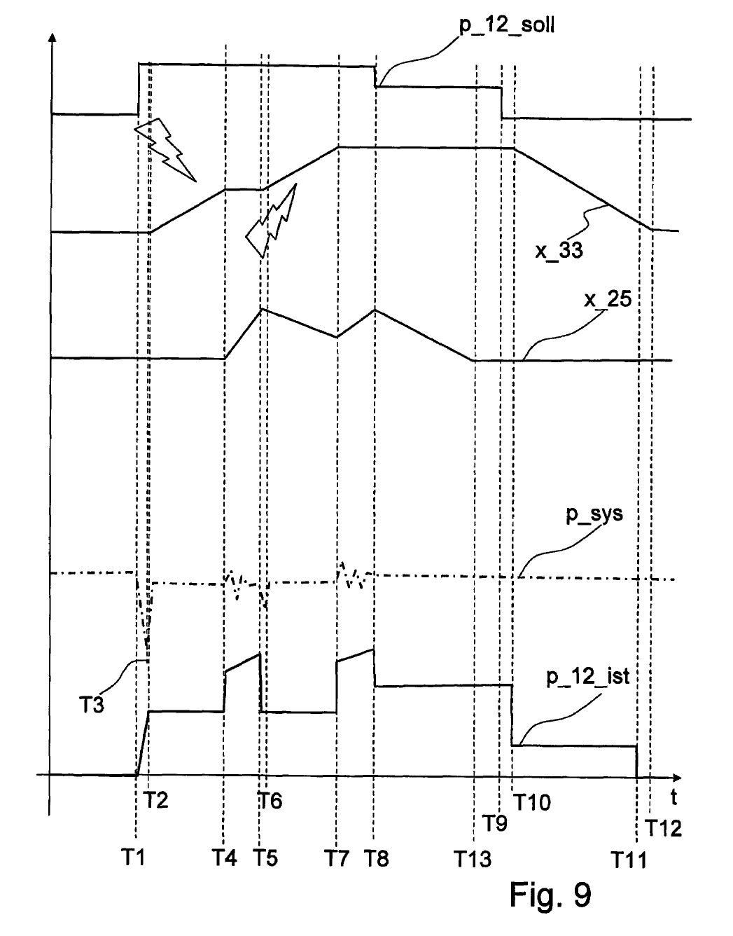

The advantageous mode of operation of the damping device 22 will be explained below on the basis of a comparison between several curves of different operating state parameters of the transmission device occurring during the closing procedure of the form-fit shifting element 12, whereby the curves shown in FIG. 8 occur during the engagement procedure of a shifting element to which no damping device is assigned. The curves shown in FIG. 9 occur during an engagement procedure of the shifting element 12 that is operatively connected to the damping device 22 in the previously described manner.

FIG. 8 and FIG. 9 respectively show, in addition to the curves of a target operating pressure p_12_soll of the form-fit shifting element that is given by an electric transmission control and which is to be suspended by the valve device 15, the curves of a target operating pressure p_12_ist of the form-fit shifting element 12 that occurs during an engagement procedure of the form-fit shifting element that lasts from time TI to time T7, and a subsequent disengagement phase of the shifting element that lasts from time T9 to time T12.

In addition, the curve of the system pressure p_sys present in the hydraulic system 11 upstream of the valve device 15, as well as the curve of the piston movement x_33 of the actuating piston 33 is shown, the curve of the piston movement x_25 of the piston 25 of the damping device 22 being plotted in FIG. 9.

At time T1, at which the form-fit shifting element 12 is in a completely disengagement operating state, the target operating pressure p_12_soll of the form-fit shifting element 12 is increased to a pressure value that engages the shifting element 12, as a result of a command to engage the form-fit shifting element 12 generated prior to time T1.

The setpoint setting causes the actual operating pressure p_1 2_ist of the shifting element 12 to rise abruptly after a short delay as well, and the actuating piston 33 to move from its first end position, in which the shifting element 12 is completely disengage in the direction of its second end position, in which the shifting element 12 is completely engaged.

During the movement phase of the actuating piston 33 of the form-fit shifting element 12, starting from its first end position and moving in the direction of its second end position, in which a first tooth profile 37 of the shifting element 12 meshes in a form-fitting manner with the second tooth profile 38, and the form-fit shifting element 12 is in its engaged operating state, a pressure is created in the piston chamber 34 of the shifting element 12 that largely corresponds to a pressure value that is equivalent to the elastic force of the third spring device 35.

The system pressure p_sys drops between time T2, which chronologically follows shortly after time T1, and an additional time T3 as a result of the piston movement of the actuating piston 33 of the shifting element 12. From this time onward, the system pressure p_sys rises again as a result of a corresponding reaction in the area of the system pressure valve and is then kept at least approximately constant.

At T4, at which the movement of the actuating piston 33 is blocked, both the actual operating pressure p_12_ist in the piston chamber 34 of the shifting element 12 and the system pressure p_sys rise, the kinetic energy of the hydraulic fluid flow that was previously conveyed in the direction of the form-fit shifting element 12 being converted to a hydrodynamic pressure and causing a considerable rise in pressure in the piston chamber 34 and in the area of the hydraulic system 11 conveying the system pressure.

The movement of the actuating piston 33 of the form-fit shifting element 12 either ends when the piston reaches the second end stop at time T7, or has previously been interrupted at T4, at which there is a so-called tooth-tooth position, in which the two tooth profiles 37 and 38 come into contact in the area of the front sides that face one other and cannot be brought into form-fitting engagement with one other to the desired extent.

The pressure peak in the hydraulic system 11, shown in FIG. 8, which was generated by the sudden stop of the piston movement at T4, is damped by the independent and single-acting piston 25, to which a separate return spring, or, as the case may be, the second spring device 23 is assigned, or by the movement of the piston in the manner shown in FIG. 9, such that a negative backlash on the rest of the hydraulic system of the transmission device 10 is avoided upstream of the valve device 15. The reduced backlash is represented in FIG. 9 by the diminished pressure fluctuations of the system pressure p_sys between times T4 and T6 compared to the progression of the system pressure p_sys in FIG. 8.

The second spring device 23 of the damping device 22 is dimensioned for this purpose such that, starting at a threshold value of the operating pressure that ideally lies below the minimum system pressure p_sys of preferably 5 bar and above the maximum operating pressure of the actuating piston 32, the piston 25 is moved from its first inactive end position in the direction of its second end position in the manner shown in FIG. 9.

This design of the second spring device 23 of the damping device 22 results in the piston 25 of the damping device 22 remaining in a first, inactive end position during the movement of the actuating piston 33 of the form-fit shifting element 12, because the actual operating pressure p_12_ist in the piston chamber 34 of the shifting element 12 during the movement of the actuating piston 33 corresponds to a pressure value that is equivalent to the elastic force of the third spring unit 35, which is smaller than the operating pressure of the piston 25, or, as the case may be, the damping device 22.

As soon as the piston movement of the actuating piston 33 is halted, the pressure in the piston chamber 34 rises to the pressure level of the third spring device 23 of the damping device 22, as a result of which the piston is displaced from its first end position in the direction of a second end position, in which the volume of the hydraulic system 11 is enlarged in the area downstream of the valve device 15. If the second spring device 23 of the damping device 22 is, for example, designed for an operating pressure of 4 bar, the pressure in the piston chamber 34, or, as the case may be, downstream of the valve device 15, rises to a maximum of 4 bar, as long as the piston 25 of the damping device 22 is in motion, whereby the hydraulic fluid volume flow that is carried in the direction of the form-fit shifting element 12 can initially be largely maintained at a constant level.

At time T5, at which the actuating piston 33 of the shifting element 12, which is by now in mesh, is moved further in the direction of its second end position, the actual operating pressure p_12 _ist downstream of the valve device 15 and in the piston chamber 34 drops to the level of the third spring device 35. The piston 25 will then no longer move in the direction of its second end position.

Because of the lower actual operating pressure p_12_ist at time T5 downstream of the valve device 15, or, as the case may be, in the area of the feed line 20 and the piston chamber 34, the piston 25 is pushed back in the direction of its first end position by the assigned spring device 23. The hydraulic fluid volume flow, which is conveyed upstream of the valve device 15 in the direction of the shifting element 12, is reduced by corresponding transmission control set points during this phase of the actuation of the shifting element 12 due to the previously occurred pressure peak in the hydraulic system 11. By resetting the piston 25 in the direction of its first end position, part of the hydraulic fluid volume required for actuating the shifting element 12 is returned to the hydraulic system 11, which at least partially compensates for the reduction in the hydraulic fluid volume flow.

At time T7, the actuating piston 33 reaches its second end stop, which is why the actual operating pressure p_12_ist in the piston chamber 34 rises again. In turn, in a transmission device that is configured without a damping device, this leads to an additional and not negligible rise in the actual operating pressure p_12_ist and the system pressure p_sys between times T7 and T9. Compared to a transmission device without a damping device, these pressure peaks are avoided or, as the case may be, considerably reduced to the extent shown in FIG. 9, by the damping device 22, or, as the case may be, by the actuation of the piston 25 in the direction of its second end position between times T7 and T8.

At the same time, the hydraulic fluid flow conveyed in the direction of the form-fit shifting element 12 via the pilot valve, or, as the case may be, the electrohydraulic actuator 16, or by means of the corresponding current feed of the electromagnetic actuator 26, is continuously reversed in order to keep the pressure peaks in the hydraulic system as low as possible, whereby the accomplishment of the second end stop, or, as the case may be, the second end position of the actuating piston 33 is verified via a known stroke management system that is not shown in more detail in the drawing, and the control of the valve device 15 required for this purpose can be implemented in due time.

In the completely engaged operating state of the form-fit shifting element 12, i.e. in a static state between times T8 and T9, in the exemplary embodiments of the hydraulic system 11 according to FIG. 2, FIG. 3, and FIG. 5 the pilot pressure p_VS_15 is set to a level at which the actuating piston 33 of the shifting element 12 remains in its second end position via the constant actual operating pressure p_12_ist in the manner shown in FIG. 9. The piston 25 of the damping device 22 is pushed back up to time T13 to its first end position, or, as the case may be, to its starting position.

In the exemplary embodiment of the hydraulic system 11 according to FIG. 3, the operating pressure p_12 in the feed line 20, or, as the case may be, in the piston chamber 34, is accordingly adjusted via the corresponding current feed of the electromagnetic actuator 26 of the valve device 15.

Based on the last described engaged operating state of the shifting element 12, in which the piston 25 is in its first end position, the fastest possible disengagement of the form-fit shifting element 12 is ensured because the disengagement procedure of the shifting element 12 is not delayed by the movement of the piston 25 in the direction of its first end position and the associated expulsion of hydraulic fluid volume into the feed line 20, or, as the case may be, into the piston chamber 34.

At time T10, at which there is a command to disengage the shifting element 12, the target operating pressure p_12_soll of the shifting element 12 drops, the actuating piston is displaced by the third spring device 35 to its first end position, and the shifting element 12 is disengaged, whereby the actual operating pressure p_12_ist corresponds to the level of the third spring device 35 during the piston movement of the actuating piston 33, and when the shifting element 12 is completely disengaged, it corresponds to the pre-filling pressure of the hydraulic system 11 that is adjusted via the additional non-return valve 31.

In principle, the operation of the actuating piston 33 of the form-fit shifting element 12 is ideally designed for a pressure level such that the actuating piston 33 is actuated below the minimum pressure value of the system pressure p_sys. However, if the pressure value of the system pressure p_sys in the hydraulic system 11 drops below the operating pressure of the actuating piston 33 of the shifting element 12, there is the undesirable possibility that the actuating piston 33 will be moved in the direction of its first end position by the third spring device 35, and the form-fit shifting element will unintentionally disengaged.

By means of the non-return valve device 27, it is ensured that the actuating piston 33 does not return to its starting position when there are undesirable drops in pressure in the hydraulic system 11. In principle, during unfavorable operating states of the hydraulic system when there are drops in pressure in the hydraulic system 11 due to the working pressure not being held constant, the valve device 15 without the non-return valve device 27 will be converted to an operating state, in which the connection between the form-fit shifting element 12 and the system pressure supply, or, as the case may be, the first hydraulic line 13, is completely disengaged. By arranging the non-return valve device 27 upstream of the fourth control guide 15_4 of the valve device 15, it is ensured that the piston chamber 34 of the form-fit shifting element 12 is not de-aerated in the direction of the area of the hydraulic system 11 that conveys the system pressure p_sys.

In the exemplary embodiments shown in the drawing, the non-return valve device 27 is configured with the bypass throttle 28, by means of which it is in turn ensured that the form-fit shifting element 12 can be safely converted to a disengaged operating state despite a failure of the valve device 15. With complete functionality of the valve device 15, the shifting element 12 is disengaged via the connection of the operating pressure and the tank connection 15_2 of the valve device 15.

As an alternative to the exemplary embodiments of the damping device shown in the drawing, each of which is configured with a piston that is tensioned by means of a spring device, and depending on the respective application, the damping device can be designed to incorporate a diaphragm spring, a gas spring, or also a membrane-gas spring combination with or without additional mechanical spring elements, like a coil spring, a disk spring, a spring element packet or the like, and/or a reversibly deformable elastic damping element, by means of which the pressure fluctuations in the feed line of the form-fit shifting element can be at least partially compensated for in the previously described manner during the actuation of the form-fit shifting element.

### REFERENCE NUMERALS

1 Vehicle
2 First vehicle axle
3 Second vehicle axle
4,5 Drive wheel
6,7 Drive shaft
8 Differential gear unit
9 Power unit
10 Transmission device
11 Hydraulic System
12 Shifting element
13 First hydraulic line
14 Pressure reducing valve
15 Valve device
15_2 to 15_4 Control guide
16 Electrohydraulic actuator
17 Control surface
18 Valve slide
19 First spring device
20 Feed line
21 Second hydraulic line
22 Damping device
23 Spring device
24 Cylinder
25 Piston
26 Electromagnetic actuator
27 Non-return valve device
28 Bypass throttle
29 Third hydraulic line
30 Non-pressurized area
31 Additional non-return valve
32 Hydraulic control
33 Actuating piston
33A Throttle device, feed throttle
34 Piston chamber
35 Third spring device
36 Spring chamber
36A Vent bore
37 First tooth profile
38 Second tooth profile
39, 40 Wheel
p_red Reduction pressure
p_sys System pressure
p_VS_15 Pilot pressure
p_12 Operating pressure of the shifting element
t Time
T0 to T13 Discrete timE

1-14. (canceled)

15. A transmission device (10) having at least one form-fit shifting element (12) hydraulically actuated via a hydraulic system (11), to which hydraulic pressure (p_12) is applied in an area of a piston chamber (34) via a feed line (20) which conveys hydraulic fluid such that the form-fit shifting element (12) is shiftable from a disengaged operating state to an engaged operating state, and a non-return valve device (27) being arranged upstream of the form-fit shifting element (12).

16. The transmission device according to claim 15, wherein the non-return valve device is switchable between at least two operating positions and, in a first operating position, the non-return valve device allows through-flow in the filling direction of the piston chamber of the form-fit shifting element and back-flow through the non-return valve device counter to the filling direction of the piston chamber of the form-fit shifting device is blocked and, in a second operating position of the non-return valve device, hydraulic fluid is conveyed counter to the filling direction of the piston chamber via the non-return valve device.

17. The transmission device according to claim 15, wherein the non-return valve device (27) has a bypass throttle (28) by which the hydraulic fluid is conveyed, by the form-fit shifting element (12), past the non-return valve device (27) counter to the reverse direction of the non-return valve (27).

18. The transmission device according to claim 15, wherein a valve device (15) is arranged between the non-return valve device (27) and the form-fit shifting element (12) and adjusts the operating pressure (p_12) of the form-fit shifting element (12).

19. The transmission device according to claim 18, wherein a first control guide (15_4) of the valve device (15) is connected to the line (13) conveying a system pressure (p_sys), and a second control guide (15_3) of the valve device (15) is connected to a non-pressurized area (30) of the hydraulic system (11), the first control guide (15_4) and the second control guide (15_3) are operationally connected to one another depending on a position of a valve slide (18) of the valve device (15).

20. The transmission device according to claim 18, wherein the feed line (20), which connects the form-fit shifting element (12) with the valve device (15) and conveys the hydraulic fluid, is operationally connected to a damping device (22) by which pressure fluctuations of the hydraulic pressure (p_12) present in the feed line (20) are at least partially compensated.

21. The transmission device according to claim 20, wherein a throttle device (33A) is provided between the damping device (22) and the valve device (15) provided for adjusting the operating pressure (p_12) of the form-fit shifting element (12).

22. The transmission device according to claim 20, wherein the damping device (22) comprises a spring device (23), which the hydraulic pressure (p_12) of the feed line (20) acts upon an active surface of a damping element (25), the elastic force of the spring device works against a compressive force of the hydraulic pressure (p_12) acting on the active surface of the damping element (25).

23. The transmission device according to claim 22, wherein the elastic force of the spring device (23) of the damping device (22) that works against the hydraulic compressive force is greater than a maximum hydraulic operating force of an actuating piston (33) of the form-fit shifting element (12).

24. The transmission device according to claim 22, wherein the elastic force of the spring device (23) of the damping device (22) that works against the hydraulic compressive force is smaller than a minimum system pressure (p_sys) of the hydraulic system (11).

25. The transmission device according to claim 20, wherein the damping device (22) is integrated in the form-fit shifting element (12).

26. The transmission device according to claim 22, wherein the damping device (22) comprises a single-acting piston-cylinder unit, and the damping element (25) is a piston that is axially displaceable within a cylinder (24) and is arranged coaxially to the actuating piston (33) of the form-fit shifting element (12).

27. The transmission device according to claim 26, wherein the piston (25) of the damping device (22) and the actuating piston (33) of the form-fit shifting element (12) are radially adjacent annular pistons.

28. The transmission device according to claim 23, wherein a stroke measurement system is assigned to the actuating piston (33) of the form-fit shifting element (12) such that at least one end position of the actuating piston (33), in which the form-fit shifting element (12) is in the engaged operating state, is verifiable.
